(19) United States
(12) Patent Application Publication
(10) Pub. No.: US 2023/0258826 A1
(43) Pub. Date: Aug. 17, 2023

(54) VEHICLE CONTROL DEVICE

(71) Applicant: Mitsubishi Electric Corporation, Tokyo (JP)

(72) Inventors: Hiroaki KITANO, Tokyo (JP); Shota KAMEOKA, Tokyo (JP)

(73) Assignee: Mitsubishi Electric Corporation, Tokyo (JP)

(21) Appl. No.: 18/012,818

(22) PCT Filed: Aug. 4, 2020
(86) PCT No.: PCT/JP2020/029809

§ 371 Date: Dec. 23, 2022

(51) Int. Cl. G01S 19/49; B60W 60/00

(52) U.S. Cl. CPC G01S 19/49; B60W 60/00; B60W 2420/00

(57) ABSTRACT

The present disclosure relates to a vehicle control device including: a satellite positioning result processing part obtaining first data from the satellite positioning device, and outputting the first data as a satellite positioning result; a sensor correction part obtaining second data from an autonomous sensor, and correcting a first error to output the corrected second data as corrected data; an inertial positioning part performing an inertial positioning calculation and outputting an inertial positioning result; an observation value prediction part performing a positioning calculation using the inertial positioning result, and calculating a prediction observation value to output the prediction observation value; an error estimation part estimating an error between the prediction observation value and a satellite positioning result to output the error as a second error; a positioning correction part correcting the prediction observation value, and outputting the prediction observation value as a corrected positioning result.

### TECHNICAL FIELD

The present disclosure relates to a vehicle control device mounted to a vehicle to control the vehicle.

### BACKGROUND ART

It is necessary to detect a road along which a vehicle should travel, generate a traveling route which is a route along which the vehicle should travel, and control the vehicle so that the vehicle travels along the generated traveling route in order to perform a drive assist of the vehicle or automatic traveling of the vehicle.

A conventional drive assist system with a detection system of detecting a compartment line by a camera has become common. However, in the system using the camera, only a range viewed by the camera can be originally detected, and there is a case where the compartment line can be hardly detected by reason that the compartment line blurs or it rains, for example.

Considered accordingly is a system of detecting a road using a satellite positioning result by a global navigation satellite system (GNSS) and map data measured with high precision. Particularly, a system of determining a position of a vehicle with high precision as typified by a quasi-zenith satellite and a network type real time kinematic (RTK) has been recently in practical use.

Patent Document 1 discloses a positioning system including: a satellite navigation part receiving a signal from a navigation satellite to determine a position of a subject vehicle; an autonomous navigation part determining a position of the subject vehicle based on an azimuth angle of the subject vehicle and a relative movement amount thereof from a predetermined position; a map database storing map data relating to a road along which the subject vehicle travels; and a positioning data usability determination part determining whether or not positioning data of the satellite navigation part can be used for controlling a vehicle. The positioning data usability determination part determines whether or not the positioning data of the satellite navigation part can be used for controlling the vehicle based on a difference between the positioning data of the satellite navigation part and the positioning data of the autonomous navigation part and a difference between the positioning data of the satellite navigation part and the map data of the map database under a condition that the number of pieces of data acquired by the navigation satellite is equal to or larger than the number of pieces of data in which the position can be determined and positioning accuracy of the acquired data by the acquired navigation satellite is equal to or higher than a predetermined accuracy. The positioning data usability determination part selects which data to use, the positioning data of the satellite navigation part or the positioning data of the autonomous navigation part, in accordance with the determination result.

### PRIOR ART DOCUMENTS

### Patent Document(s)

Patent Document 1: Japanese Patent Application Laid-Open No. 2017-3395

### SUMMARY

### Problem to be Solved by the Invention

In the technique disclosed in Patent Document 1, only the positioning data of the autonomous navigation part is used when there is a problem in the positioning data of the satellite navigation part, and an error caused by the autonomous navigation part itself is not considered, thus there is a problem in accuracy of estimating the position of the subject vehicle.

The present disclosure therefore has been made to solve problems as described above, and it is an object to provide a vehicle control device in which accuracy of estimating a position of a vehicle is improved.

### Means to Solve the Problem

A vehicle control device according to the present disclosure is a vehicle control device estimating a position of a vehicle using a satellite positioning device and an autonomous sensor to control the vehicle including: a satellite positioning result processing part obtaining first data including a positioning solution state from the satellite positioning device, and processing the first data to output the processed first data as a satellite positioning result; a sensor correction part obtaining second data indicating a state amount of the vehicle from the autonomous sensor, and correcting a first error included in the second data to output the second, which has been corrected, as corrected data; an inertial positioning part performing an inertial positioning calculation based on the corrected data outputted from the sensor correction part to output an inertial positioning result; an observation value prediction part performing a positioning calculation using the inertial positioning result outputted from the inertial positioning part, and calculating a prediction observation value for estimating a correction amount of the second data outputted from the autonomous sensor to output the calculated prediction observation value; an error estimation part estimating an error between the prediction observation value outputted from the observation value prediction part and a satellite positioning result outputted from the satellite positioning result processing part to output the error as a second error, and outputting a correction amount of the autonomous sensor calculated based on the second error; a positioning correction part correcting the prediction observation value based on the prediction observation value outputted from the observation value prediction part and the second error outputted from the error estimation part to output the corrected prediction observation value as a corrected positioning result; and a vehicle control part making the vehicle travel along a road using the corrected positioning result outputted from the positioning correction part, wherein the error estimation part changes an error estimation parameter in accordance with the positioning solution state.

### Effects of the Invention

According to the vehicle control device of the present disclosure, the error of the autonomous sensor can be accurately corrected by changing an error estimation parameter in accordance with the positioning solution state in the error estimation part, thus accuracy of estimating the position of the vehicle can be improved, and accuracy of vehicle control can be improved.

### BRIEF DESCRIPTION OF DRAWINGS

FIG. 1 A diagram illustrating a whole configuration of a vehicle including a vehicle control device according to an embodiment 1.

FIG. 2 A block diagram illustrating a configuration of the vehicle control device according to the embodiment 1.

FIG. 3 A flow chart for describing process in the vehicle control device according to the embodiment 1.

FIG. 4 A diagram illustrating a hardware configuration achieving the vehicle control device according to the embodiment 1.

FIG. 5 A diagram illustrating a hardware configuration achieving the vehicle control device according to the embodiment 1.

### DESCRIPTION OF EMBODIMENT(S)

### Embodiment 1

<Configuration of Device>

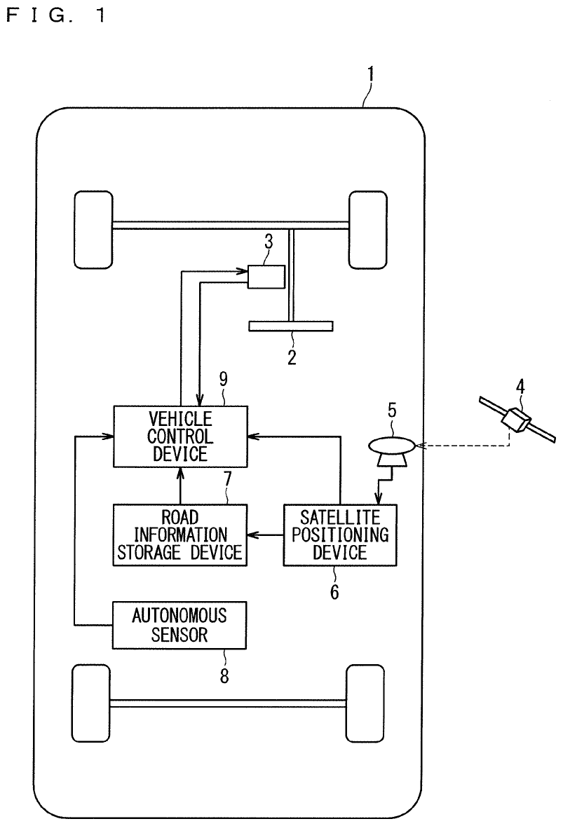

FIG. 1 is a diagram illustrating a whole configuration of a vehicle 1 provided with a vehicle control device according to an embodiment 1. As illustrated in FIG. 1, a steering actuator 3 is attached to a handle 2 operating two tires of front wheels in the vehicle 1.

The steering actuator 3 includes an electronic power steering (EPS) motor and an electronic control unit (ECU), for example, and operates in accordance with a steering command from the vehicle control device 9, thereby being able to control rotations of the handle 2 and the front wheel.

In the vehicle 1, the steering actuator 3 is controlled in accordance with a steering command value inputted from the vehicle control device 9, and steering control is performed so that the vehicle 1 travels along a road.

The vehicle 1 includes an antenna 5 receiving a signal from a satellite 4, a satellite positioning device 6, a road information storage device 7, and an autonomous sensor 8 mounted to the vehicle 1 to detect a state amount of a vehicle such as a yaw rate sensor and a vehicle speed sensor, for example.

The satellite 4 is made up of a plurality of global positioning system (GPS) satellites, for example, however, the satellite 4 is not limited to the GPS satellite, but the other positioning satellite such as a global navigation satellite system (GLONASS), for example, can also be applied thereto.

The antenna 5 receives a satellite signal from the satellite 4, and transmits the received signal to the satellite positioning device 6.

The satellite positioning device 6 as an external sensor is made up of a GNSS receiver (GNSS sensor), for example, to process the satellite signal received by the antenna 5 and transmit a position and an azimuth angle of the vehicle 1 and a positioning solution state to the road information storage device 7 and the vehicle control device 9.

Some GNSS sensor has a function of outputting a positioning calculation result positioning-calculated in the GNSS sensor and observation data of the GNSS before the positioning calculation as positioning raw data in accordance with a setting of output. The positioning raw data includes a pseudo distance observation value, a Doppler observation value, and a carrier wave phase observation value, and these observation values are obtained for each frequency range delivered from the satellite (for example, L1 band, L2 band, and L5 band).

Examples of the positioning satellite include a global navigation satellite system (GLONASS) in Russia, a galileo in Europe, a quasi-zenith satellite system (QZSS) in Japan, a beidou in China, a navigation indian constellation (NavIC) in India in addition to a GPS in U.S., and all of them can be applied to the vehicle control device 9 according to the embodiment 1.

The satellite positioning device 6 according to the present embodiment 1 can perform any positioning system of a single positioning, a differential global positioning system (DGPS) positioning, an RTK positioning, and a network type RTK positioning, for example, based on a corrected signal from a quasi-zenith satellite which has become common and corrected information via Internet by a network terminal not shown in the diagrams to detect the position with high accuracy, and the positioning solution state described above indicates which positioning system described above the result is obtained from.

The single positioning is a type of a satellite positioning system performing positioning using pseudo distance observation values received from four or more positioning satellites.

The DGPS positioning is a positioning system performing positioning calculation using a satellite-based augmentation system (SBAS), an electrical reference point, and satellite positioning error reinforcement data which can be generated from a private fixed station, thereby being able to obtain a highly accurate satellite positioning result compared with the single positioning.

The RTK positioning is a positioning system transmitting an electrical reference point and satellite raw data of a private fixed station to a mobile station, and eliminating a cause of a satellite positioning error near a base station, thereby achieving a highly accurate satellite positioning. The RTK positioning is capable of performing positioning with accuracy of cm level when an integer valuable referred to as an ambiguity is obtained with high reliability. The positioning solution at this time is referred to as a Fix solution, and when the ambiguity is not obtained, a Float solution is outputted.

The network type RTK positioning is a positioning system obtaining satellite positioning data corresponding to an installation of a base station using network to perform highly accurate positioning. When the cause of the satellite positioning error described above is obtained using network, for example, the satellite positioning device 6 outputs a Fix solution when an ambiguity is obtained, and outputs a Float solution when an ambiguity is not obtained. When the cause of the satellite positioning error described above is not obtained, the satellite positioning device 6 outputs a positioning solution obtained by the DGPS solution using the satellite positioning error reinforcement data described above. Furthermore, when the cause of the satellite positioning error described above and the satellite positioning error reinforcement data described above are not obtained, the satellite positioning device 6 outputs a positioning solution obtained by the single positioning. When the positioning solution is obtained by the network type RTK positioning system, the positioning solution state indicates the network type RTK positioning system. When the positioning solution is obtained by the DGPS positioning system, the positioning solution state indicates the DGPS positioning system. When the positioning solution is obtained by the single positioning system, the positioning solution state indicates the single positioning system. That is to say, the positioning solution state indicates the positioning system itself for obtaining the positioning solution.

It is also applicable to combine a yaw rate sensor and a vehicle speed sensor and calculate a position and an azimuth angle of the subject vehicle to detect a more robust position to deal with disturbance, thereby achieving a configuration capable of dead reckoning.

The vehicle control device 9 is made up as an ECU generating a steering command value transmitted to the steering actuator 3, and outputs a target steering angle as the steering command value based on a position, an azimuth angle and, positioning solution state inputted from the satellite positioning device 6, road information inputted from the road information storage device 7, and a vehicle speed and a yaw rate inputted from the autonomous sensor 8.

The road information storage device 7 outputs road information of a road along which the vehicle 1 travels such as point group information of a latitude and a longitude of a center of a traffic lane, the number of traffic lanes, and a curvature, for example, in accordance with the position and the azimuth angle inputted from the satellite positioning device 6. It is also possible to output road information converted into a coordinate system in which the subject vehicle or a position near the subject vehicle is set to an origin point using the azimuth angle inputted from the satellite positioning device 6.

In FIG. 1, the satellite positioning device 6 and the road information storage device 7 have configurations different from each other, but can also have a configuration that both types of processing are performed in one configuration.

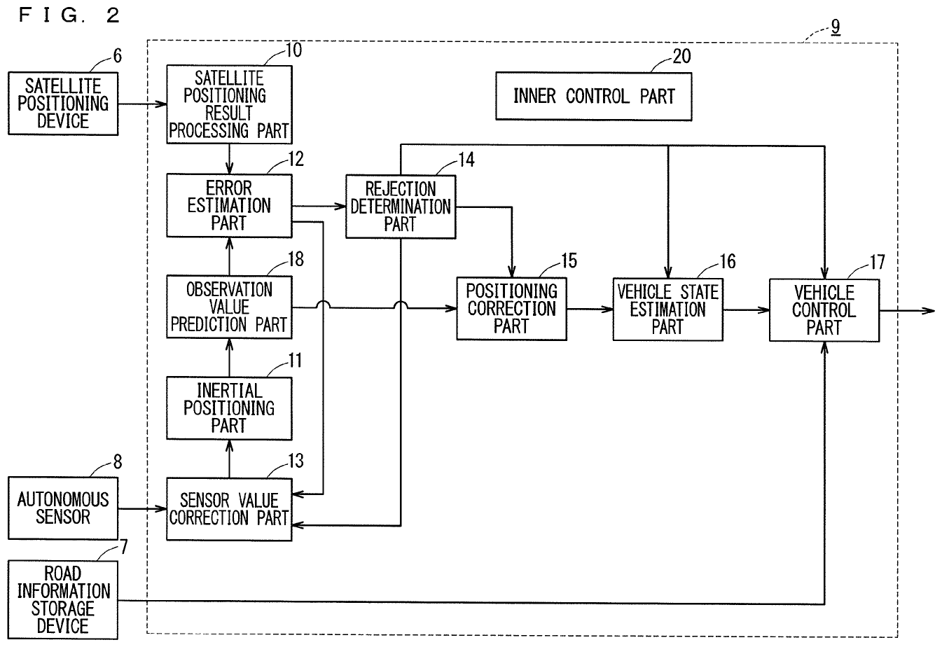

Next, a configuration of the vehicle control device 9 according to the embodiment 1 is described with reference to FIG. 2. FIG. 2 is a block diagram illustrating a configuration of the vehicle control device 9 according to the embodiment 1.

As illustrated in FIG. 2, the vehicle control device 9 includes a satellite positioning result processing part 10, an inertial positioning part 11, an error estimation part 12, a sensor value correction part 13, a rejection determination part 14, a positioning correction part 15, a vehicle state estimation part 16, a vehicle control part 17, and an observation value prediction part 18. There is an inner control part 20 controlling the whole vehicle control device 9. A connection relationship between the inner control part 20 and each member is complex, thus the illustration is omitted. The satellite positioning device 6, the road information storage device 7, and the autonomous sensor 8 are connected to the vehicle control device 9.

The satellite positioning result processing part 10 receives a positioning result (first data) including a latitude, a longitude, a height, an azimuth, and a positioning solution state as the output from the satellite positioning device 6 necessary to estimate a positioning calculation and a correction amount of a sensor value of the autonomous sensor 8, processing the positioning result to be usable in the vehicle control device 9, and outputs it as a satellite positioning result to the error estimation part 12.

The sensor value correction part 13 obtains a sensor value (second data) outputted from the autonomous sensor 8, corrects a sensor error such as a scale factor and a bias included in the sensor value, and outputs the corrected sensor value. The sensor value correction part 13 further performs buffering on the input to compensate for a delay of positioning processing performed in the vehicle state estimation part 16 described hereinafter, delays the corrected sensor value (corrected data) by a delay time, and outputs the corrected sensor value to the inertial positioning part 11.

The inertial positioning part 11 performs inertial positioning calculation of a position, an attitude, and a speed as a positioning result of the vehicle 1 using the corrected sensor value, and outputs the inertial positioning result to the observation value prediction part 18.

The observation value prediction part 18 calculates a prediction observation value necessary to perform a positioning calculation and estimate a correction amount of state amount data outputted from the autonomous sensor 8 using the inertial positioning result inputted from the inertial positioning part 11, and outputs the prediction observation value to the error estimation part 12.

The error estimation part 12 estimates an error between a satellite positioning result from the satellite positioning result processing part 10 and the prediction observation value from the observation value prediction part 18, and outputs the estimated error to the rejection determination part 14.

The rejection determination part 14 determines whether or not to reject the satellite positioning result based on the inputted estimation error, outputs the determination result to the vehicle state estimation part 16 and the vehicle control part 17, and outputs the estimation error to the sensor value correction part 13 and the positioning correction part 15.

The positioning correction part 15 corrects the prediction observation value inputted from the observation value prediction part 18 using the estimation error inputted from the rejection determination part 14, and outputs the prediction observation value as the corrected positioning result to the vehicle state estimation part 16.

The vehicle state estimation part 16 outputs to the vehicle control part 17 a vehicle state amount in which a delay time occurring by positioning processing is compensated on the corrected positioning result inputted from the positioning correction part 15.

<Operation>

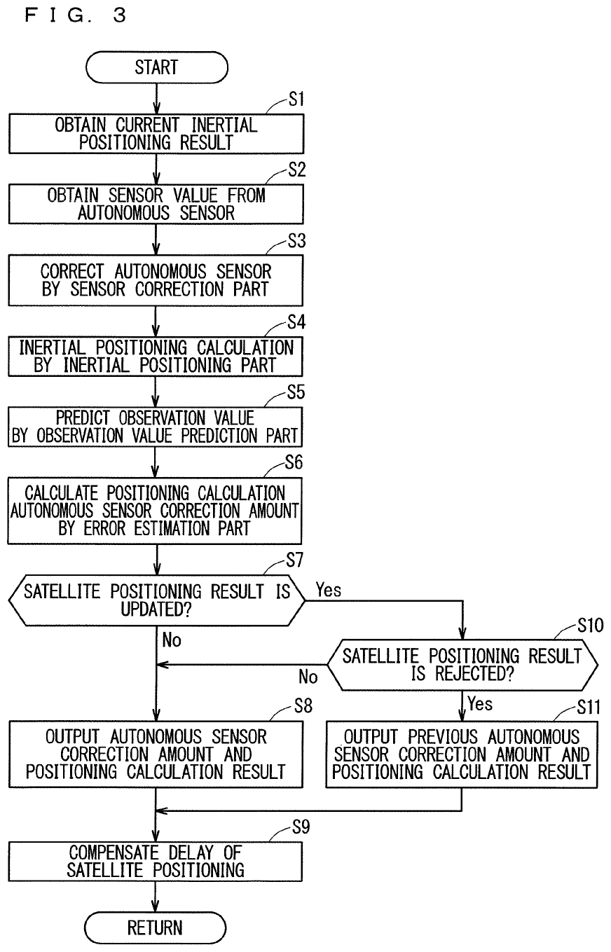

Next, a processing flow of the vehicle control device 9 according to the embodiment 1 is described using a flow chart illustrated in FIG. 3.

When the vehicle control device 9 starts the operation, the vehicle control device 9 obtains an initial value of an inertial positioning or a current inertial positioning result used in the error estimation part 12 under control of the inner control part 20 (Step S1). In a case where the current inertial positioning result cannot be obtained such as a case of immediately after turning on a power source of the vehicle control device 9, an approx positioning result from the GNSS sensor can be used, or a predetermined value as the initial value of the inertial positioning can be used.

Next, the sensor value correction part 13 obtains the sensor value from the autonomous sensor 8 (Step S2). That is to say, the autonomous sensor 8 includes a vehicle speed meter measuring a vehicle speed of a vehicle, an inertial measurement unit (IMU) measuring an acceleration rate and an angular speed of the vehicle, and a sensor such as a steering angle meter measuring a steering angle of the vehicle, for example, and obtains the acceleration rate and the angular speed from the IMU, and obtains the vehicle speed from the vehicle speed meter.

The vehicle speed meter is attached to vehicle wheels of the vehicle 1, and has a function of converting a rotational speed of the vehicle wheels into a vehicle speed of the vehicle using an output from a pulse sensor detecting the rotational speed of the vehicle wheels.

The IMU is disposed on a roof or in an inner side of the vehicle 1, and has a function of detecting an acceleration rate and an angular speed in a vehicle coordinate system. Commercial supplied is an IMU into which a micro electric mechanical system (MEMS) and a fiber optic gyroscope, for example, are incorporated.

Next, the sensor value of the autonomous sensor 8 is corrected in the sensor value correction part 13 (Step S3). Furthermore, buffering is performed on the sensor value of the autonomous sensor 8 to compensate for the delay time of positioning processing described hereinafter.

That is to say, the satellite positioning device 6 processes the received satellite signal, and the delay time occurs in a process of transmitting the satellite signal to the vehicle control device 9 and a process of receiving the satellite signal in the vehicle control device 9. When the delay time increases, stability of control and control performance finally decrease, the delay time needs to be compensated. The vehicle control device 9 according to the embodiment 1 performs buffering of a sample corresponding to the delay time as a constant time, and performs error estimation using the delayed sensor value of the autonomous sensor 8. Accordingly, a difference occurring between the satellite positioning result and the autonomous sensor 8 is resolved, and estimation accuracy is improved.

<Correction of Sensor Value of Autonomous Sensor>

Described hereinafter is a case where a vehicle speed meter and an angular speed (referred to as yaw rate hereinafter) sensor in both axis directions of the vehicle are used as the autonomous sensor 8, and correction is performed using a sensor error model expressed by Expression (1) and Expression (2) described hereinafter.

[Expression 1]

V=(1+sᵥ)Vₜ (1)
V: sensor value of vehicle speed
Vₜ: true value of vehicle speed
sᵥ: scale factor of vehicle speed

[Expression 2]

γ=(1+s_{γ})(γt+b_{γ}) (2)
γ: sensor value of yaw rate
γₜ: true value of yaw rate
s_{γ}: scale factor of yaw rate
b_{γ}: bias of yaw rate sensor

Expression (1) is a model in which a true value Vₜ of the vehicle speed is multiplied by a scale factor sᵥ of a vehicle speed, and Expression (2) is a model in which a bias by of a yaw rate sensor is superposed on a true value γₜ of a yaw rate, and true value γₜ of a yaw rate is multiplied by a scale factor s_{γ} of the yaw rate.

In this example, estimation values sᵥₑ, s_{γe}, and b_{γe} of sᵥ, s_{γ}, and b_{γ} respectively, are estimated as sensor errors in the error estimation part 12 described hereinafter. The sensor value correction part 13 corrects the sensor value of the autonomous sensor 8 by Expressions (3) and (4) using the estimation value of the sensor error estimated in the error estimation part 12.

$$\begin{matrix}[ Expression 3 ] & \\ {V}_{e} = \frac{1}{1 + {s}_{ν e}} V & ( 3 )\end{matrix}$$

$$\begin{matrix}[ Expression 4 ] & \\ {γ}_{e} = \frac{1}{1 + {s}_{γ e}} γ - {b}_{γ e} & ( 4 )\end{matrix}$$

Vₑ and γₑ are the corrected vehicle speed and yaw rate in Expressions (3) and (4). The sensor error model described above is an example, thus the other sensor error model may be used.

Herein, returning to the description of the flow chart in FIG. 3, processing of Step S4 is performed in the inertial positioning part 11. That is to say, an inertial positioning calculation is performed in the inertial positioning part 11 using the corrected sensor value and a movement model of the vehicle. The vehicle is assumed to be basically moved in a plane and is modeled as a particular calculation method of the inertial positioning calculation. The vehicle is expressed by a navigation coordinate system conforming to an ellipsoidal body of geodetic reference system 1980 (GRS 80) hereinafter. Firstly, a state variable expressed by the following Expression (5) is defined.

[Expression 5]

y_{d}=[λ_{d} ϕ_{d} h_{d} ψ_{f}]^{T} (5)

y_{d} in Expression (5) expresses a state vector regarding an inertial positioning in which a state variable regarding the inertial positioning is collected. λ_{d} expresses a latitude obtained by the inertial positioning calculation, φ_{d} expresses a longitude obtained by the inertial positioning calculation, hd expresses a height of an ellipsoidal body obtained by the inertial positioning calculation, and ψ_{d} expresses an azimuth obtained by the inertial positioning calculation.

This state variable is modeled by a movement model expressed by the following Expression (6).

$$\begin{matrix}[ Expression 6 ] & \\ {y}_{d} . = g ( {y}_{d} , u ) = [ \begin{matrix}\begin{matrix}\begin{matrix}\frac{V cos {ψ}_{d}}{M + {h}_{d}} \\ \frac{V sin {ψ}_{d}}{( N + {h}_{d} ) cos {λ}_{d}}\end{matrix} \\ 0\end{matrix} \\ γ\end{matrix} ] & ( 6 )\end{matrix}$$

λ_{d}: latitude by inertial positioning [rad]

φ_{d}: longitude by the inertial positioning [rad]

h_{d}: height of ellipsoidal body by inertial positioning [m]

ψ_{d}: azimuth by inertial positioning [rad]

V: vehicle speed [m/sec]

γ: yaw rate [rad/sec]

a: equatorial radius (=6378137.0[m])

Fe: earth oblateness (=1/298.257223563)

y_{d}. in Expression (6) expresses a vector in which a state vector regarding an inertial positioning is temporally differentiated. g(y_{d}, u) is a non-linear function in which y_{d} and u are input, and u is an input vector in which input variables V and 7 are collected, and expresses u=[V_{γ}]^{T}.

N in Expression (6) expresses a prime vertical radius, M expresses a meridian radius, and they are defined by the following Expressions (7) and (8), respectively.

$$\begin{matrix}[ Expression 7 ] & \\ N = \frac{a}{{( 1 - {e}^{2} {sin}^{2} {λ}_{d} )}^{1 / 2}} & ( 7 )\end{matrix}$$

$$e = eccentricity ( = \sqrt{( {F}_{e} ( 2 - {F}_{e} )} )$$

$$\begin{matrix}[ Expression 8 ] & \\ M = \frac{a ( 1 - {e}^{2} )}{{( 1 - {e}^{2} {sin}^{2} {λ}_{d} )}^{3 / 2}} & ( 8 )\end{matrix}$$

The corrected sensor value is assigned to Expression (6), and integration is performed every moment, thus the inertial positioning result can be obtained. A method such as Runge-Kutta method is normally used as an integration method. A coordinate of a latitude, a longitude, and a height of an inertial navigation is a coordinate of a center of a navigation of the vehicle.

When the satellite positioning device 6 is made up of a GNSS receiver (GNSS sensor), for example, the coordinate of the GNSS is updated using information obtained by the inertial positioning. The update of the coordinate of the GNSS sensor is described hereinafter.

<Update of Coordinate of GNSS Sensor>

Herein, returning to the description of the flow chart in FIG. 3, processing of Step S5 is performed in the observation value prediction part 18. That is to say, the observation value obtained by the GNSS sensor is coordinate information of a latitude, a longitude, and a height of the antenna 5. The observation value of the GNSS sensor is referred to as (λₘ, φₘ, hₘ, ψₘ) hereinafter. In the meanwhile, these pieces of coordinate information is also obtained in the inertial positioning result, however, the inertial positioning result is the coordinate of the center of the navigation of the vehicle, thus the observation value of the GNSS sensor is predicted using a compensation amount from the center of the navigation of the vehicle to the position of the antenna 5. That is to say, when the compensation amount from the center of the navigation of the vehicle expressed by the navigation coordinate system of the vehicle to the antenna 5 is (Δx, Δy, Δz), the predicted observation value (λₚ, φₚ, hₚ, ψₚ) of the GNSS sensor can be obtained as the following Expression (9) from the inertial positioning value y_{d} (λ_{d}, φ_{d}, h_{d}, ψ_{d}) and the compensation amount v (Δx, Δy, Δz) by the coordinate conversion function c (y_{d}, v).

$$\begin{matrix}[ Expression 9 ] & \\ [ \begin{matrix}{λ}_{p} \\ {ϕ}_{p} \\ {h}_{p} \\ {ψ}_{p}\end{matrix} ] = c ( {λ}_{d} , {ϕ}_{d} , {h}_{d} , {ψ}_{d} , Δ x , Δ y , Δ z ) & ( 9 )\end{matrix}$$

Herein, returning to the description of the flow chart in FIG. 3, the processing of Step S6 is performed. That is to say, the error estimation part 12 estimates the error (second error) between the satellite positioning result obtained from the satellite positioning device 6 and the prediction observation value obtained in Step S5, calculates the corrected sensor value of the autonomous sensor 8, that is to say, the autonomous sensor correction amount based on the estimated error; outputs the autonomous sensor correction amount to the sensor value correction part 13, and outputs the estimated error to the rejection determination part 14.

Next, processing of Step S7 is performed. That is to say, the error estimation part 12 determines whether or not the satellite positioning result received from the satellite positioning device 6 is updated. That is to say, the inertial positioning part 11 compares the satellite positioning result obtained in Step S4 and the satellite positioning result received from the satellite positioning device 6 at a time of a previous sampling, and when these results are the same as each other, the inertial positioning part 11 determines that the data from the satellite positioning device 6 is not updated, and when these results are different from each other, the inertial positioning part 11 determines that the data from the satellite positioning device 6 is updated. Then, when the data from the satellite positioning device 6 is updated (in a case of Yes), the process proceeds to Step S10. In the meanwhile, when the data is not updated (in a case of No), the process proceeds to processing of Step S8 in the inertial positioning part 11.

In Step S8, the autonomous sensor correction amount calculated by the error estimation part 12 and the result of the inertial positioning calculation obtained in Step S4 are outputted to the positioning correction part 15. When the autonomous sensor correction amount is not obtained, the value of the previous calculation result is outputted as the autonomous sensor correction amount, and the result of the inertial positioning calculation obtained in Step S4 is outputted to the positioning correction part 15.

<Method of Estimating Error>

A method of estimating an error in the error estimation part 12 is described hereinafter. Firstly, defined is a state vector x expressed by the following Expression (10) having a variable to be estimated as a latitude, a longitude, a height, an azimuth, a vehicle speed scale factor, a yaw rate scale factor, and a yaw rate bias.

[Expression 10]

x=[λϕhψsᵥ s_{γ}b_{γ}]^{T} (10)

When the scale factor sᵥ of the vehicle speed and the scale factor s_{γ} of the yaw rate are minute, the true value Vₜ of the vehicle speed and the true value γₜ of the yaw rate can be approximated by the following Expressions (11) and (12), respectively, in accordance with Expressions (3) and (4).

[Expression 11]

Vₜ=(1−sᵥ)V (11)

[Expression 12]

γₜ=(1−s_{γ})γ−b_{γ} (12)

A dynamic model of the scale factor sᵥ of the vehicle speed, the scale factor s_{γ} of the yaw rate, and a bias b_{γ} of the yaw rate sensor is expressed by the following Expressions (13), (14), and (15). That is to say, the driving is based on a primary Markov process of predicting a next state from a current state.

[Expression 13]

sᵥ.=(−sᵥ+wₛᵥ)/τₛᵥ (13)

Wₛᵥ=process noise of vehicle speed scale factor [−]

τₛᵥ=model parameter value of vehicle speed scale factor [sec]

[Expression 14]

s_{γ}.=(−s_{γ}+w_{sγ})/τ_{sγ} (14)

W_{sγ}=process noise of yaw rate scale factor [−]

τ_{sγ}=model parameter value of yaw rate scale factor [sec]

[Expression 15]

b_{γ}.=(−b_{γ}+w_{bγ})/τ_{bγ} (15)

W_{bγ}=process noise of yaw rate bias [rad/sec]

T_{bγ}=model parameter value of yaw rate bias [sec]

In Expressions (13) to (15), sᵥ. is a temporal differentiation of sᵥ, s_{γ}. is a temporal differentiation of s_{γ}, and b_{γ}. is a temporal differentiation of by. The process noise W_{Sv} of the vehicle speed scale factor is a noise regarding a time transition of the vehicle speed scale factor, the process noise W_{Sγ} of the yaw rate scale factor is a noise regarding a time transition of the yaw rate scale factor, and the process noise W_{bγ} of the yaw rate bias is a noise regarding a time transition of the yaw rate bias.

When Expressions (13) to (15) are collected, a state equation can be expressed by the following Expression (16).

$$\begin{matrix}[ Expression 16 ] & \\ x . = f ( x , u ) := [ \begin{matrix}\frac{( 1 - {s}_{ν} ) V cos ψ}{M + h} \\ \frac{( 1 - {s}_{ν} ) V sin ψ}{( N + h ) cos λ} \\ 0 \\ ( 1 - {s}_{γ} ) γ - {b}_{γ} \\ - {s}_{ν} / {τ}_{s ν} \\ - {b}_{γ} / {τ}_{b γ}\end{matrix} ] & ( 16 )\end{matrix}$$

In Expression (16), x. expresses a vector in which the state vector x is temporally differentiated. u is an input vector which can be expressed by the following Expression (17).

[Expression 17]

u[Vγ]^{T} (17)

Expression (16) is the state equation and Expression (9) is an observation equation by the GNSS sensor to estimate the state vector x, thus the satellite positioning calculation and the error of the autonomous sensor 8 can be estimated.

The state equation of Expression (16) and the observation equation of Expression (9) are non-linearly formed in relation to the state vector, thus a non-linear state estimation needs to be applied to estimate the positioning calculation and the error of the autonomous sensor 8. Applicable as a method of estimating the non-linear state is a known method such as particulate filter referred to as a particle filter or a sequential Monte Carlo method and an extended Kalman filter, for example. These methods are methods of estimating a most stochastically probable state, and are often used for a state estimation problem.

Described hereinafter is a method using the extended Kalman filter. The state variable is estimated in the Kalman filter based on an assumption that noise associated with the system conforms to gauss distribution, and the Kalman filter is advantageous in mounting by reason that calculation load is small and a calculation circuit can be small compared with the particulate filter.

<State Estimation by Extended Kalman Filter>

A primary Taylor-expansion of Expression (16) around a prior estimation value x_{b} of the state vector can be expressed by the following Expression (18).

[Expression 18]

δx.=Fₐδx+w (18)

In Expression (18), w is a process noise, and δx is an error state vector which can be expressed by the following Expression (19).

[Expression 19]

δx:=x−x_{b} (19)

Fa can be expressed by the following Expression (20) in Expression (18).

$$\begin{matrix}[ Expression 20 ] & \\ {{F}_{a} := \frac{\partial f}{\partial x} \vert}_{x = {x}_{b}} & ( 20 )\end{matrix}$$

An observation equation z by the GNSS sensor is expressed as the following Expression (21).

[Expression 21]

z=[λₚΠₚhₚψₚ]^{T} (21)

The observation equation z can be expressed as a function of the state vectors x and u, and all of the observation equations z can be described as the following Expression (22) in the above state.

[Expression 22]

z=h₀(x. u) (22)

A Taylor-expansion of Expression (22) around a prior estimation value x_{b} of the state vector x can be expressed by the following Expressions (23) and (24).

$$\begin{matrix}[ Expression 23 ] & \\ {δ z = \frac{\partial {h}_{0}}{\partial x} \vert}_{x = {x}_{b}} δ x & ( 23 )\end{matrix}$$

$$\begin{matrix}[ Expression 24 ] & \\ δ z = H δ x & ( 24 )\end{matrix}$$

In Expression (23), the output vector z is an observation equation expressed by Expression (22) described previously.

In Expression (24), H is a matrix in which a primary Taylor-expansion is performed on the observation equation regarding the state vector x, and the prior estimation value x_{b} is assigned as x, and is expressed by the following Expression (25).

$$\begin{matrix}[ Expression 25 ] & \\ {H := \frac{\partial {h}_{0}}{\partial x} \vert}_{x = {x}_{b}} & ( 25 )\end{matrix}$$

The matrix H can be analytically obtained or can be calculated using numerical differentiation.

When Expression (18) and Expression (24) are discretized by a sampling time Δt of the autonomous sensor 8 and a discrete time is k, the following Expression (26) and Expression (27) are established.

[Expression 26]

δxₖ=Fδxₖ₋₁+wₖ (26)

[Expression 27]

δzₖ=Hδxₖ+vₖ (27)

In Expression (26) and Expression (27), F is a state transition matrix regarding an error state vector δxₖ regarding a time k, and is expressed as F=(1+Fₐ.dt) and wₖ=w. Δt. vₖ is a sensor noise corresponding to each observation value. The process noise w and the sensor noise vₖ are parameters of the Kalman filter, and can be set using a prior measurement value, for example.

When a processing algorithm of the Kalman filter is applied using Expression (26) and Expression (27), the estimation value δx_{e, k} of the error state vector at the discrete time k can be obtained.

<Time Evolution Processing>

Time evolution processing is processing executed every sampling time of the autonomous sensor 8. A prior estimation value x_{b, k} at the time k is expressed by the following Expression (28) using an inertial positioning result y_{d, k} at the time k and an autonomous sensor error e_{sensor, k}.

[Expression 28]

x_{b,k}=[y_{d,k}^{T}e_{sensor,k}^{T}]^{T} (28)

When the prior estimation value of the error state vector at the time k is δx_{b, k}, an error covariance matrix is Pₖ (n×n matrix), and a prior error covariance matrix is P_{b, k} (n×n matrix), the prior estimation value δx_{b, k} and the prior error covariance matrix P_{b, k} are expressed by the following Expression (29) and Expression (30), respectively, and the time evolution processing is performed.

[Expression 29]

δx_{b,k}=Fδx_{b,k-1} (29)

[Expression 30]

P_{b,k}=FPₖ₋₁F^{T}+Q (30)

In Expression (30), Q is a covariance matrix (n×n matrix) of a process noise having a variance of wₖ as a diagonal element. An initial value of the error covariance matrix is necessary immediately after turning on a power source, for example, and often used for the initial value is Pₖ₋₁ expressed by the following Expression (31) using an optional scalar value a equal to or larger than 0 and a unit matrix I_{n×n} of n×n. A vector in which all of elements of δx_{b, k} is set to 0 is used as an initial value of δx_{b, k}.

[Expression 31]

Pₖ₋₁=α·I_{n×n} (31)

<Observation Update Processing>

Observation update processing defined by the following Expressions (32), (33), and (34) is performed at a time when an observation value is obtained by an external sensor.

[Expression 32]

Gₖ=P_{b,k}H^{T}(HP_{b,k}H^{T}+R)⁻¹ (32)

[Expression 33]

δx_{e,k}=δx_{b,k}+Gₖ(δzₖ−Hδx_{b,k}) (33)

[Expression 34]

Pₖ=(I_{n×n}−GₖH)P_{b,k} (34)

In Expressions (32) to (34), δx_{e, k} is an estimation value of the error state vector, R is a covariance matrix (p×p matrix) of the sensor noise, and Gₖ is a Kalman gain.

δzₖ is a vector expressed by the following Expression (35) in which z_{m, k} is an actual observation value at the time k and z_{p, k} is a predicted observation value.

[Expression 35]

δzₖ=z_{m,k}−z_{p,k} (35)

According to this process, the estimation value δx_{e, k} of the error state vector at the time k is obtained, thus the estimation value x_{e, k} of the state vector xₖ can be obtained as the following Expression (36).

[Expression 36]

x_{e,k}=x_{b,k}+δx_{e,k} (36)

The positioning solution of the GNSS sensor changes depending on a positioning system such as a single positioning, a DGPS positioning, an RTK positioning, and a network type RTK positioning, for example, and positional accuracy of the satellite positioning result is different depending on the positioning system, thus a good result is achieved by increasing a value of the element of the covariance matrix R of the sensor noise as the error estimation parameter is increased in accordance with decrease in accuracy of the positioning solution. However, a Doppler observation value of the GNSS signal can be used for accuracy of the azimuth in the satellite positioning result, thus accuracy is hardly deteriorated by an influence of multipath, for example. Thus, even when the positioning solution changes, an element relating to the azimuth ψ in the element of the covariance matrix R of the sensor noise needs not be changed. Accordingly, the element of the position of the covariance matrix R of the sensor noise is increased, and the element of the azimuth of the covariance matrix R of the sensor noise is not changed or a ratio of increase thereof is set to be smaller than the element of the position of the covariance matrix R of the sensor noise, thus the estimation corresponding more to the model of the sensor can be achieved, and estimation accuracy is improved.

Herein, returning to the description of the flow chart in FIG. 3, the processing of Step S10 in the rejection determination part 14 is performed. That is to say, the rejection determination part 14 determines rejection of the satellite positioning result based on an estimation error obtained in Step S6.

The error covariance matrix Pₖ in Expression (34) expresses a distribution regarding the difference between the true value of the state vector and the estimated value, and an abnormal value of the external sensor can be determined using this value. The number of rotations of vehicle wheels is generally output with high precision by a vehicle wheel speed pulse attached to the vehicle wheels of a vehicle, thus reliability of the position in a short time is increased compared with the satellite positioning result easily influenced by a multipath, for example. Thus, applicable is a configuration of a rejection mechanism in which elements for a latitude and a longitude of the error covariance matrix Pₖ are extracted, an ellipsoid referred to as an error ellipsoid is obtained by performing an eigenvalue analysis, and when the sensor value of the GNSS sensor is included within a range of the error ellipsoid, the sensor value is used as the observation value, and when it is not included, it is rejected as the abnormal value, and is not used as the observation value, for example. Accordingly, the observation value having low accuracy can be rejected, and estimation accuracy can be improved.

When a state where the observation value is not updated is continued, a radius of an error ellipsoid calculated from the error covariance matrix Pₖ increases in accordance with a time. That is to say, the observation value is not obtained, thus a state defined with a predetermined probability based on the covariance matrix Q of the process noise, that is a range of a latitude and a longitude of in this example increases. Thus, a travel traffic lane of road information transmitted from the road information storage device 7 and the error ellipsoid are compared, and when it is determined that the error ellipsoid is beyond the travel traffic lane, outputted to the vehicle control part 17 is a command of suspending vehicle control or switching to control using the other camera and the other sensor such as a light detection and ranging (LiDAR), for example. Accordingly, a vehicle can be safely controlled even in a case where estimation accuracy is reduced.

A similar rejection mechanism can be configured even in a case of using a particle filter, and more reliable estimation can be performed by rejecting an abnormal value.

In Step S10, when it is determined that the satellite positioning result is not rejected (in a case of No), the process proceeds to processing of Step S8 in the inertial positioning part 11. In Step S8, a result of the autonomous sensor correction amount calculated in Step S6 and the result of the inertial positioning calculation calculated by a method described hereinafter are outputted to the positioning correction part 15.

In the meanwhile, when it is determined that the satellite positioning result is rejected in Step S10 (in a case of Yes), a value of the previous calculation result is outputted as the autonomous sensor correction amount, and a result of the inertial positioning calculation obtained in Step S4 is outputted as the result of the inertial positioning calculation (Step S11).

The processing of Steps S1 to S11 is repeated every time the sampling in the autonomous sensor 8 is performed, and when the state where the satellite positioning result is rejected is continued for a predetermined period of time in Step S10, the rejection determination part 14 outputs information that reliability of the inertial positioning calculation is reduced to the vehicle control part 17.

In the inertial positioning calculation in Step S8, the estimation value of the state vector is expressed as a state vector xₑ, and is defined as the following Expression (37).

[Expression 37]

xₑ=[λₑϕₑhₑψₑsᵥₑs_{γe}b_{γe}]^{T} (37)

In Expression (37), λₑ, φₑ, hₑ, and ψₑ are estimation values of a latitude, a longitude, a height, and an azimuth, respectively, and sᵥₑ, s_{γe}, b_{γe} are estimation values of a vehicle speed scale factor, a yaw rate scale factor, and a yaw rate bias, respectively.

When yₑ=[λₑφₑhₑψₑ]^{T} is established, the positioning calculation result yₒᵤₜ is expressed by the following Expression (38).

[Expression 38]

yₒᵤₜ=yₑ (38)

The autonomous sensor error eₛₑₙₛₒᵣ is expressed by the following Expression (39), and inputted to the sensor value correction part 13.

[Expression 39]

eₛₑₙₛₒᵣ=[sᵥₑs_{γe}b_{γe}]^{T} (39)

Processing of Step S9 in the vehicle state estimation part 16 is described next. In Step S9, a delay time of the positioning processing in the satellite positioning device 6 is compensated on the positioning calculation result outputted through the processing in Step S8 using the sensor value of the autonomous sensor 8 on which buffer has been performed in Step S3. Specifically, it is assumed that the vehicle movement is not changed during a delay time Td in a current time Tk, and as indicated by the following Expression (40), the vehicle speed and the yaw rate of the autonomous sensor on which the buffering has been performed are corrected by the autonomous sensor corrected amount outputted in Step S8, and the corrected vehicle speed and the yaw rate are integrated by the delay time Td based on the positioning calculation result yₒᵤₜ as an initial value and outputted to the vehicle control part 17 as a positioning calculation result y_{comp} after the compensation of the delay time.

[Expression 40]

yₑ=yₒᵤₜ+∫_{Tk-Td}^{Tk}g(yd(t),u(t))dt (40)

Accordingly, estimation can be performed while a temporal difference between the autonomous sensor 8 and the satellite positioning result is suppressed, the positioning calculation result in which the delay from an actual time is compensated can be outputted, and positional accuracy and control performance can be improved.

The vehicle control part 17 makes the vehicle 1 travel along a road based on output from the rejection determination part 14, the positioning correction part 15, the vehicle state estimation part 16, and the road information storage device 7.

Specifically, a road around the subject vehicle obtained from the road information storage device 7 is converted into a subject vehicle coordinate system based on a vehicle coordinate and an attitude of the vehicle obtained by the positioning correction part 15, and vehicle control is performed to eliminate deviation of a position of the subject vehicle from the road to be traveled. Various methods are proposed as a method of vehicle control, and examples thereof include a method of performing feedback of only deviation of a position to control it, a method using an angular deviation of the subject vehicle from a road, and a method using a curvature of a road, however, all of them are commonly known, thus the description thereof is omitted.

As described already, when the rejection of the satellite positioning result in the rejection determination part 14 is continued and it is determined that reliability is reduced, the vehicle control part 17 suspends vehicle control or switches to control using the other camera and the other sensor such as a LiDAR, for example.

As described above, according to the vehicle control device 9 of the embodiment 1, the covariance matrix (error estimation parameter) of the sensor noise is sequentially changed in accordance with a state of the positioning solution of the GNSS sensor, thus the error of the autonomous sensor 8 itself and the error of the prediction observation value can be accurately compensated, and the position of the subject vehicle can be accurately estimated. Even when estimation accuracy of the position of the subject vehicle is reduced by reason that the accuracy of the positioning satellite data is reduced, the vehicle control is suspended or switched to the vehicle control using the other sensor, thus the accuracy of the vehicle control can be maintained.

<Hardware Configuration>

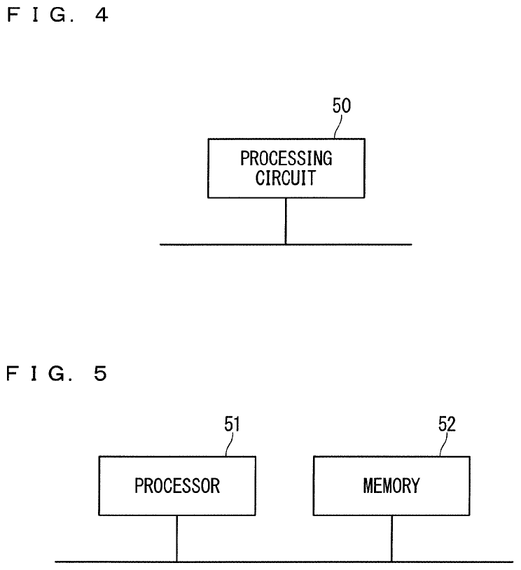

Each constituent element of the vehicle control device 9 according to the embodiment 1 described above can be configured using a computer, and is achieved when the computer executes a program. That is to say, the vehicle control device 9 is achieved by a processing circuit 50 illustrated in FIG. 4, for example. A processor such as a central processing unit (CPU) and a digital signal processor (DSP) is applied to the processing circuit 50, and a function of each part is achieved by executing a program stored in a storage device.

Dedicated hardware may be applied to the processing circuit 50. When the processing circuit 50 is the dedicated hardware, a single circuit, a complex circuit, a programmed processor, a parallel-programmed processor, an application specific integrated circuit (ASIC), a field-programmable gate array (FPGA), or a combination of them, for example, falls under the processing circuit 50.

In the vehicle control device 9, each function of the constituent element may be achieved by an individual processing circuit, or functions may be collectively achieved by one processing circuit.

FIG. 5 illustrates a hardware configuration in a case where the processing circuit 50 is configured using a processor. In this case, the function of each part of the vehicle control device 9 is achieved by a combination with software etc. (software, firmware, or software and firmware). The software etc. is described as a program and is stored in a memory 52. A processor 51 functioning as the processing circuit 50 reads out and executes a program stored in the memory 52 (storage device), thereby achieving the function of each part. That is to say, this program is considered to make the computer execute a procedure and a method of an operation of the constituent elements of the vehicle control device 9.

Herein, the memory 52 may be a non-volatile or volatile semiconductor memory such as a RAM, a ROM, a flash memory, an erasable programmable read only memory (EPROM), or an electrically erasable programmable read only memory (EEPROM), a hard disk drive (HDD), a magnetic disc, a flexible disc, an optical disc, a compact disc, a mini disc, a digital versatile disc (DVD), or a drive device of them, or any storage medium which is to be used in the future.

Described above is a configuration that the function of each constituent element of the vehicle control device 9 is achieved by one of the hardware and the software. The configuration is not limited thereto, however, also applicable is a configuration that some constituent element of the vehicle control device 9 is achieved by dedicated hardware and the other some constituent element thereof is achieved by software, for example. For example, the function of some constituent element can be achieved by the processing circuit 50 as the dedicated hardware, and the function of the other constituent element can be achieved by the processing circuit 50 as the processor 51 reading out and executing the program stored in the memory 52.

As described above, the vehicle control device 9 can achieve each function described above by the hardware, the software, or the combination of them, for example.

Although the present disclosure is described in detail, the foregoing description is in all aspects illustrative and does not restrict the present disclosure. It is therefore understood that numerous modification examples not illustrated can be devised without departing from the scope of the present disclosure.

According to the present disclosure, each embodiment can be appropriately varied or omitted within the scope of the invention.

1. A vehicle control device estimating a position of a vehicle using a satellite positioning device and an autonomous sensor to control the vehicle, the vehicle control device comprising:
a satellite positioning result processing circuitry obtaining first data including a positioning solution state from the satellite positioning device, and processing the first data to output the processed first data as a satellite positioning result;
a sensor correction circuitry obtaining second data indicating a state amount of the vehicle from the autonomous sensor, and correcting a first error included in the second data to output the second data, which has been corrected, as corrected data;
an inertial positioning circuitry performing an inertial positioning calculation based on the corrected data outputted from the sensor correction circuitry to output an inertial positioning result;
an observation value prediction circuitry performing a positioning calculation using the inertial positioning result outputted from the inertial positioning circuitry, and calculating a prediction observation value for estimating a correction amount of the second data outputted from the autonomous sensor to output the calculated prediction observation value;
an error estimation circuitry estimating an error between the prediction observation value outputted from the observation value prediction circuitry and a satellite positioning result outputted from the satellite positioning result processing circuitry to output the error as a second error, and outputting a correction amount of the autonomous sensor calculated based on the second error;
a positioning correction circuitry correcting the prediction observation value based on the prediction observation value outputted from the observation value prediction circuitry and the second error outputted from the error estimation circuitry to output the corrected prediction observation value as a corrected positioning result; and
a vehicle control circuitry making the vehicle travel along a road using the corrected positioning result outputted from the positioning correction circuitry, wherein
the error estimation circuitry changes an error estimation parameter in accordance with the positioning solution state.

2. The vehicle control device according to claim 1, wherein
the error estimation parameter is a covariance matrix of a sensor noise.

3. The vehicle control device according to claim 1, wherein
the vehicle control device further comprises a rejection determination circuitry determining whether or not the satellite positioning result is rejected using the second error,
the correction amount of the autonomous sensor is not used when the satellite positioning result is rejected, and
the correction amount of the autonomous sensor is used when the satellite positioning result is not rejected.

4. The vehicle control device according to claim 1, wherein
the error estimation circuitry calculates a covariance matrix of the second error,
the rejection determination circuitry determines whether or not a travel traffic lane of the vehicle in road information includes an error ellipsoid based on the error ellipsoid obtained from the covariance matrix of the second error and the road information, and
when the travel traffic lane of the vehicle does not include the error ellipsoid, the vehicle control circuitry limits vehicle control using the corrected positioning result.

5. The vehicle control device according to claim 1, wherein
the sensor correction circuitry performs buffering on the second data in which the first error is corrected by a time corresponding to a delay time of calculation of the satellite positioning result caused by transmission-reception processing of the first data from the satellite positioning result processing circuitry.

6. The vehicle control device according to claim 5, further comprising
a vehicle state estimation circuitry outputting a vehicle state amount in which the delay time of calculation of the satellite positioning result is compensated on the corrected positioning result outputted from the positioning correction circuitry, wherein
the vehicle state estimation circuitry integrates the second data, in which the first error is corrected and on which buffering is performed, by the delay time of calculation using the inertial positioning result as an initial value, thereby compensating the delay time of calculation.
